(19) United States
(12) Patent Application Publication
(10) Pub. No.: US 2014/0118382 A1
(43) Pub. Date: May 1, 2014

(54) METHOD FOR PROGRAMMING EXTENDED DISPLAY IDENTIFICATION DATA AND DISPLAY DEVICE

(71) Applicant: WISTRON CORPORATION, New Taipei City (TW)

(72) Inventors: Jun-Xin Qiu, New Taipei City (TW); Yong-Qiang Li, New Taipei City (TW); Zheng-Ying Gao, New Taipei City (TW); Yong-Zhi Wang, New Taipei City (TW)

(73) Assignee: WISTRON CORPORATION, New Taipei City (TW)

(21) Appl. No.: 13/711,630

(22) Filed: Dec. 12, 2012

(30) Foreign Application Priority Data
Oct. 25, 2012 (CN) 201210412957.8

(51) Int. Cl. G06T 1/60

(52) U.S. Cl. CPC G06T 1/60
USPC 345/565

(57) ABSTRACT

A method for programming extended display identification data (EDID) adapted to a display device is provided. The display device has at least one EDID chip, a microcontroller unit chip, and a flash memory chip. in the method, a first EDID corresponding to the EDID chip is written into a firmware stored in the flash memory chip. The display device is powered on. The first EDID in the firmware is automatically written into the corresponding EDID chip as a second EDID by the microcontroller unit chip.

### CROSS-REFERENCE TO RELATED APPLICATION

This application claims the priority benefit of China application serial no. 201210412957.8, filed on Oct. 25, 2012. The entirety of the above-mentioned patent application is hereby incorporated by reference herein and made a part of this specification.

### BACKGROUND OF THE INVENTION

1. Field of the Invention

The invention generally relates to a data burning method, and more particularly, to an extended display identification data (EDID) programming method and a display device.

2. Description of Related Art

To support the extended display identification data (EDID) standard established by the Video Electronics Standards Association (VESA), an electrically erasable programmable read only memory (EEPROM) is usually adopted at each input terminal of a display device (for example, a projector, a monitor, or a digital television) for storing an EDID content table corresponding to the input terminal. During a mass production process, in order to speed up the process, part of the information required by an EDID content table (for example, the manufacturing date and serial number of a display device) is read from a barcode and then programmed into the EEPROM along with other contents. However, different display devices have different EDID contents and barcode formats.

In a conventional technique for programming EDID content tables, different programming programs and jigs corresponding to different barcode formats and display devices have to be respectively developed (when an EDID content table is programmed, the EEPROM is installed onto the jig, while the jig is connected to a computer running the programming program through a connector). While faced with the manufacturing and packaging of different display devices, those work on the production line have to be familiar with different types of display devices in order to switch to the correct programming program and jig.

With the conventional technique, the developers have to spend a lot of time on editing EDID content tables, writing programming programs, and developing jigs for different types of display devices. Besides, because different display devices are corresponding to different programming programs and jigs, the training management and jig management on the production line are complicated and the EDID programming efficiency is reduced.

### SUMMARY OF THE INVENTION

Accordingly, the invention is directed to an extended display identification data (EDID) programming method, in which an EDID in a firmware is automatically written into a corresponding EDID chip, so that the manpower is reduced, the programming time is shortened, and the manufacturing cost is reduced.

The invention is directed to a display device, in which an EDID is automatically written into a corresponding EDID chip without unplugging/replugging a connector.

The invention provides a method for programming EDID adapted to a display device. The display device has at least one EDID chip, a microcontroller unit chip, a flash memory chip, and an electrically erasable programmable read only memory (EEPROM). The EEPROM is used for storing software related settings, such as an EDID version code. The method includes following steps. A first EDID corresponding to the EDID chip is written into a firmware stored in the flash memory chip. The display device is powered on. The first EDID in the firmware is automatically written by the microcontroller unit chip into the corresponding EDID chip as a second EDID.

According to an embodiment of the invention, in the method, the step of automatically writing the first EDID into the corresponding EDID chip further includes following steps. Whether a third EDID is already written into the EDID chip is determined. If the third EDID is not written into the EDID chip, the first EDID in the firmware is automatically written into the corresponding EDID chip as the second EDID.

According to an embodiment of the invention, in the method, the step of determining whether the third EDID is already written into the EDID chip includes determining whether an EDID version code is stored in the EEPROM.

According to an embodiment of the invention, in the method, if the EDID version code is stored in the EEPROM, it is determined the third EDID is already written into the corresponding EDID chip, and when the EDID version code is not stored in the EEPROM, it is determined the third EDID is not written into the corresponding EDID chip.

According to an embodiment of the invention, the method further includes storing an EDID version code into the EEPROM after the step of automatically writing the first EDID into the corresponding EDID chip.

According to an embodiment of the invention, the method further includes determining whether the first EDID and the second EDID respectively written into the firmware and the EDID chip are identical after the step of automatically writing the first EDID into the corresponding EDID chip and before the step of storing the EDID version code into the EEPROM.

According to an embodiment of the invention, the method further includes following step. When the first EDID and the second EDID respectively written into the firmware and the EDID chip are not identical, the first EDID in the firmware is written once again by the microcontroller unit chip into the corresponding EDID chip as the second EDID.

The invention also provides a display device including at least one EDID chip, a flash memory chip, and a microcontroller unit chip. The flash memory chip stores a firmware. A first EDID corresponding to the EDID chip is written in the firmware. The microcontroller unit chip is connected with the EDID chip via a display data channel (DDC). After the display device is powered on, the microcontroller unit chip automatically writes the first EDID in the firmware into the corresponding EDID chip as a second EDID via the DDC.

According to an embodiment of the invention, in the display device, the microcontroller unit chip further determines whether a third EDID is already written in the EDID chip, and if the third EDID is not written in the EDID chip, the microcontroller automatically writes the first EDID in the firmware into the corresponding EDID chip as the second EDID.

According to an embodiment of the invention, in the display device, when the microcontroller unit chip determines whether the third EDID is already written in the EDID chip, it further determines whether an EDID version code is stored in the EEPROM.

According to an embodiment of the invention, in the display device, if the EDID version code is stored in the EEPROM, the microcontroller determines that the third EDID is already written in the corresponding EDID chip, and if the EDID version code is not stored in the EEPROM, the microcontroller determines that the third EDID is not written in the corresponding EDID chip.

According to an embodiment of the invention, in the display device, after automatically writing the first EDID into the corresponding EDID chip, the microcontroller unit chip further stores an EDID version code into the EEPROM.

According to an embodiment of the invention, in the display device, after automatically writing the first EDID into the corresponding EDID chip and before storing the EDID version code into the EEPROM, the microcontroller unit chip further determines whether the first EDID and the second EDID respectively written into the firmware and the EDID chip are identical.

According to an embodiment of the invention, in the display device, if the first EDID and the second EDID respectively written into the firmware and the EDID chip are not identical, the microcontroller unit chip writes the first EDID in the firmware into the corresponding EDID chip as the second EDID once again.

According to an embodiment of the invention, in the display device, the EDID chip includes an EEPROM chip.

According to an embodiment of the invention, in the display device, the microcontroller unit chip is installed in a microcontroller for processing video graphics array (VGA) signals, digital visual interface (DVI) signals, or high-definition multimedia interface (HDMI) signals.

According to an embodiment of the invention, in the display device, the flash memory chip includes a flash memory.

As described above, an EDID is written into a firmware of a display device in advance, and the EDID in the firmware is automatically written into a corresponding EDID chip by a microcontroller unit chip. Thus, the complicated procedure in the conventional technique for programming EDID respectively into corresponding EDID chips by repeatedly unplugging and replugging different display devices can be avoided. Thereby, the manpower is reduced, the programming time is shortened, and the manufacturing cost is reduced.

These and other exemplary embodiments, features, aspects, and advantages of the invention will be described and become more apparent from the detailed description of exemplary embodiments when read in conjunction with accompanying drawings.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a diagram of a display device according to an embodiment of the invention.

FIG. 2 is a flowchart of an extended display identification data (EDID) programming method according to an embodiment of the invention.

FIG. 3 is a flowchart of an EDID programming method according to another embodiment of the invention.

### DESCRIPTION OF THE EMBODIMENTS

Reference will now be made in detail to the present preferred embodiments of the invention, examples of which are illustrated in the accompanying drawings.

Wherever possible, the same reference numbers are used in the drawings and the description to refer to the same or like parts.

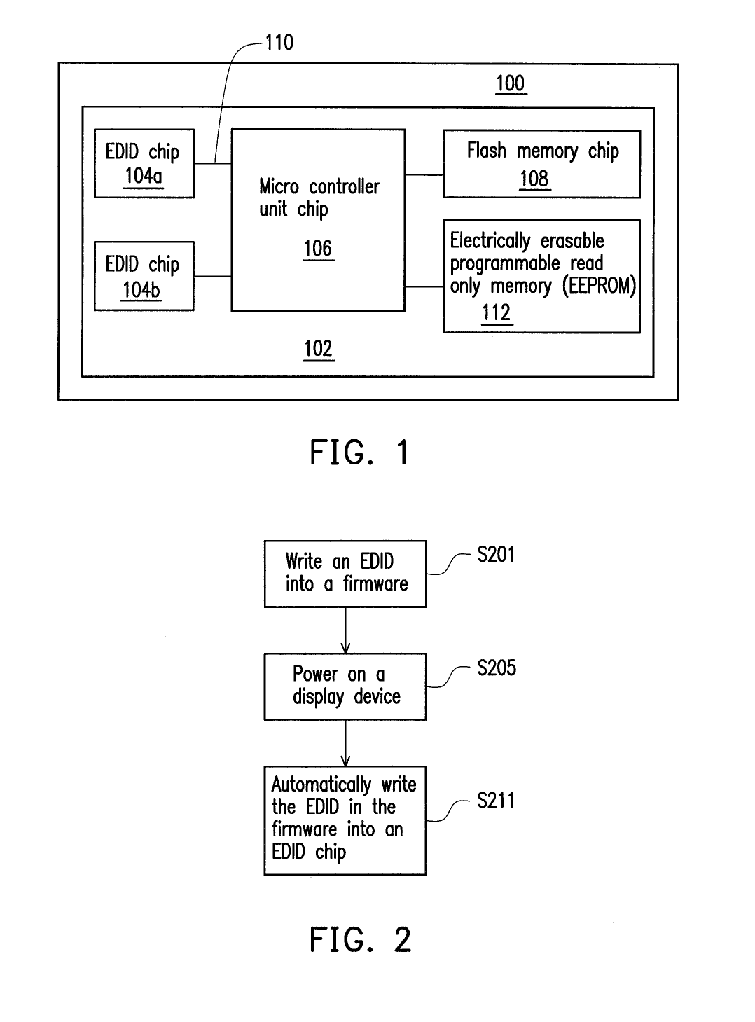

FIG. 1 is a diagram of a display device according to an embodiment of the invention. FIG. 2 is a flowchart of an extended display identification data (EDID) programming method according to an embodiment of the invention. Referring to FIG. 1, the display device 100 in the present embodiment includes a main board 102. At least one EDID chip is installed on the main board 102. In the present embodiment, two EDID chips 104a and 104b are installed on the main board 102. The EDID chips 104a and 104b include an electrically erasable programmable read only memory (EEPROM) chip, such as a video graphics array (VGA) chip, a digital visual interface (DVI) chip, or a high-definition multimedia interface (HDMI) chip.

A microcontroller unit chip 106, a flash memory chip 108, and an EEPROM 112 are also installed on the main board 102. The microcontroller unit chip 106 is configured to process VGA signals, DVI signals, or HDMI signals. Besides, the microcontroller unit chip 106 is connected with the EDID chips via a display data channel (DDC) 110. Moreover, the flash memory chip 108 is used for storing a firmware. The EEPROM 112 is used for storing software related settings, such as an EDID version code.

Referring to FIG. 1 and FIG. 2, the EDID programming method in the present embodiment is adapted to the display device 100. In step S201, EDID corresponding to the EDID chips 104a and 104b is respectively written into the firmware stored in the flash memory chip 108. Herein an EDID includes a display type and a chromaticity number, wherein the display type may be RGB color, grayscale, or non-RGB multicolour.

Then, in step S205, power is supplied to the display device 100 (i.e., the display device 100 is turned on). Next, in step S211, the EDID in the firmware is automatically written by the microcontroller unit chip 106 into the corresponding EDID chips 104a and 104b through the DDC 110.

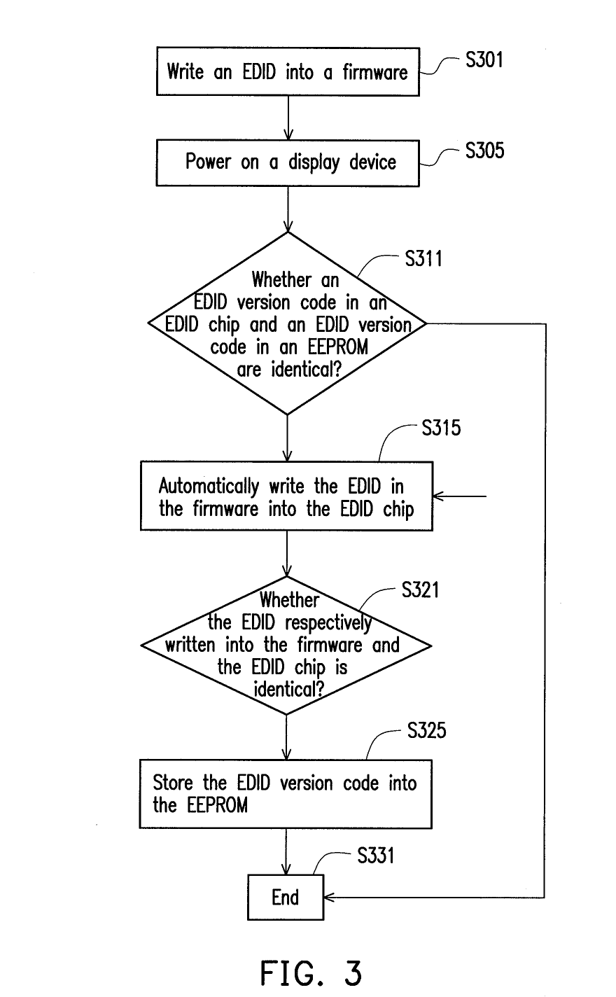

FIG. 3 is a flowchart of an EDID programming method according to another embodiment of the invention. The EDID programming method in the present embodiment includes foregoing step of directly and automatically writing the EDID in the firmware into the corresponding EDID chip and the steps before and after the EDID writing step to ensure that the EDID is not repeatedly written and the written EDID is correct. Referring to FIG. 1 and FIG. 3, in step S301, the EDID corresponding to the EDID chips 104a and 104b is respectively written into the firmware stored in the flash memory chip 108. Herein each EDID includes a display type and a chromaticity number, wherein the display type may be RGB color, grayscale, or non-RGB multicolour.

Next, in step S305, power is supplied to the display device 100 (i.e., the display device 100 is turned on). In step S311, an EDID version code is read from the EEPROM 112, and the EDID version code is compared with the EDID version code of the EDID written into the flash memory chip 108. If the two EDID version codes are identical, the EDID programming procedure of the current EDID chip is ended (step S311). On the other hand, if the EDID version code read from the EEPROM 112 is different from the EDID version code written into the flash memory chip 108, the microcontroller unit chip 106 automatically writes the EDID in the firmware into the corresponding EDID chip which contains no EDID through the DDC 110 (step S315).

It should be noted that the step of determining whether any EDID has been written in the EDID chips 104a and 104b may be that the microcontroller unit chip 106 determines whether an EDID version code is stored in the EEPROM 112. To be specific, if an EDID version code is stored in the EEPROM 112, it can be determined that the EDID has been written in the corresponding EDID chip (for example, the EDID chips 104a and 104b). On the other hand, if no EDID version code is stored in the EEPROM 112, it can be determined that the EDID has not been written in the corresponding EDID chip (for example, the EDID chips 104a and 104b).

After the microcontroller unit chip 106 automatically writes the EDID into the corresponding EDID chip (step S315), in step S321, whether the EDID respectively written into the firmware and the EDID chips 104a and 104b is identical is determined The step 321 is executed to prevent any error in the written EDID caused by unexpected power failure when the microcontroller unit chip 106 writes the EDID into the EDID chip.

When it is determined that the EDID respectively written into the firmware and the EDID chip is identical, in step S325, the microcontroller unit chip 106 stores the EDID version code corresponding to the EDID into the EEPROM 112, and the EDID programming procedure is ended here (step S331).

On the other hand, when it is determined that the EDID respectively written into the firmware and the EDID chip is not identical, the microcontroller unit chip 106 writes the EDID in the firmware into the corresponding EDID chip once again (step S315).

In the invention, an EDID is written into a firmware of a display device in advance, and the EDID in the firmware is automatically written into a corresponding EDID chip by a microcontroller unit chip. Thus, the complicated procedure in the conventional technique for programming EDID respectively into corresponding EDID chips by repeatedly unplugging and replugging different display devices can be avoided. Thereby, the manpower is reduced, the programming time is shortened, and the manufacturing cost is reduced.

It will be apparent to those skilled in the art that various modifications and variations can be made to the structure of the invention without departing from the scope or spirit of the invention. In view of the foregoing, it is intended that the invention cover modifications and variations of this invention provided they fall within the scope of the following claims and their equivalents.

What is claimed is:

1. A method for programming extended display identification data, adapted to a display device, wherein the display device has at least an extended display identification data chip, a microcontroller unit chip, a flash memory chip, and an electrically erasable programmable read only memory, the method comprising:
writing a first extended display identification data corresponding to the extended display identification data chip into a firmware stored in the flash memory chip;
powering on the display device; and
the microcontroller unit chip automatically writing the first extended display identification data in the firmware into the corresponding extended display identification data chip as a second extended display identification data.

2. The method according to claim 1, wherein the step of automatically writing the first extended display identification data into the corresponding extended display identification data chip further comprises:
determining whether a third extended display identification data is already written in the extended display identification data chip; and
when the third extended display identification data is not written in the extended display identification data chip, automatically writing the first extended display identification data in the firmware into the corresponding extended display identification data chip as the second extended display identification data.

3. The method according to claim 2, wherein the step of determining whether the third extended display identification data is already written in the extended display identification data chip comprises determining whether an extended display identification data version code is stored in the electrically erasable programmable read only memory.

4. The method according to claim 3, wherein
when the extended display identification data version code is stored in the electrically erasable programmable read only memory, it is determined the third extended display identification data is already written in the corresponding extended display identification data chip; and
when the extended display identification data version code is not stored in the electrically erasable programmable read only memory, it is determined the third extended display identification data is not written in the corresponding extended display identification data chip.

5. The method according to claim 1, after the step of automatically writing the first extended display identification data into the corresponding extended display identification data chip, further comprising storing an extended display identification data version code into the electrically erasable programmable read only memory.

6. The method according to claim 5, after the step of automatically writing the first extended display identification data into the corresponding extended display identification data chip and before the step of storing the extended display identification data version code into the electrically erasable programmable read only memory, further comprising determining whether the first extended display identification data and the second extended display identification data respectively written into the firmware and the extended display identification data chip are identical.

7. The method according to claim 6 further comprising:
when the first extended display identification data and the second extended display identification data respectively written into the firmware and the extended display identification data chip are not identical, writing the first extended display identification data in the firmware into the corresponding extended display identification data chip as the second extended display identification data once again by using the microcontroller unit chip.

8. A display device, comprising:
at least an extended display identification data chip;
a flash memory chip, storing a firmware, wherein a first extended display identification data corresponding to the extended display identification data chip is written in the firmware; and
a microcontroller unit chip, connected with the extended display identification data chip via a display data channel, wherein after the display device is powered on, the microcontroller unit chip automatically writes the first extended display identification data in the firmware into the corresponding extended display identification data chip as a second extended display identification data through the display data channel.

9. The display device according to claim 8, wherein the microcontroller unit chip further determines whether a third extended display identification data is already written in the extended display identification data chip, and when the third extended display identification data is not written in the extended display identification data chip, the microcontroller unit chip automatically writes the first extended display identification data in the firmware into the corresponding extended display identification data chip as the second extended display identification data.

10. The display device according to claim 9, wherein when the microcontroller unit chip determines whether the third extended display identification data is already written in the extended display identification data chip, the microcontroller unit chip further determines whether an extended display identification data version code is stored in an electrically erasable programmable read only memory.

11. The display device according to claim 10, wherein
when the extended display identification data version code is stored in the electrically erasable programmable read only memory, the microcontroller unit chip determines that the third extended display identification data is already written in the corresponding extended display identification data chip; and
when the extended display identification data version code is not stored in the electrically erasable programmable read only memory, the microcontroller unit chip determines that the third extended display identification data is not written in the corresponding extended display identification data chip.

12. The display device according to claim 8, wherein after automatically writing the first extended display identification data into the corresponding extended display identification data chip, the microcontroller unit chip further stores an extended display identification data version code into the electrically erasable programmable read only memory.

13. The display device according to claim 12, wherein after automatically writing the first extended display identification data into the corresponding extended display identification data chip and before storing the extended display identification data version code into the electrically erasable programmable read only memory, the microcontroller unit chip further determines whether the first extended display identification data and the second extended display identification data respectively written into the firmware and the extended display identification data chip are identical.

14. The display device according to claim 13, wherein
when the first extended display identification data and the second extended display identification data respectively written into the firmware and the extended display identification data chip are not identical, the microcontroller unit chip writes the first extended display identification data in the firmware into the corresponding extended display identification data chip as the second extended display identification data once again.

15. The display device according to claim 8, wherein the extended display identification data chip comprises an electrically erasable programmable read only memory chip.

16. The display device according to claim 8, wherein the microcontroller unit chip is installed in a microcontroller for processing video graphics array signals, digital visual interface signals, or high-definition multimedia interface signals.

17. The display device according to claim 8, wherein the flash memory chip comprises a flash memory.
